(19) United States
(12) Patent Application Publication
(10) Pub. No.: US 2022/0169951 A1
(43) Pub. Date: Jun. 2, 2022

(54) AUTOMATIC DISHWASHING COMPOSITIONS AND METHOD OF CLEANING ARTICLES

(71) Applicant: Dow Global Technologies LLC, Midland, MI (US)

(72) Inventors: Severine Ferrieux, Grasse (FR); Eric Wasserman, Collegeville, PA (US)

(21) Appl. No.: 17/602,371

(22) PCT Filed: May 26, 2020
(86) PCT No.: PCT/US2020/034470

§ 371 Date: Oct. 8, 2021

(30) Foreign Application Priority Data
Jun. 5, 2019 (EP) 19290034.8

(51) Int. Cl. C11D 3/37; C11D 1/722; C11D 3/10; C11D 3/20; C11D 11/00

(52) U.S. Cl. CPC C11D 3/3757; C11D 3/3749; C11D 3/378; C11D 11/0035; C11D 3/10; C11D 3/2082; C11D 3/2086; C11D 1/722

(57) ABSTRACT

An automatic dishwashing composition is provided including a maleic acid/olefin copolymer; a dispersant polymer, comprising a copolymer of acrylic acid and a sulfonated monomer; a builder; and a surfactant of formula I:

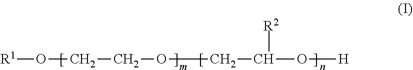

wherein R¹ is a linear or branched, saturated C₈₋₂₄ alkyl group; R² is a linear saturated C₂₋₈ alkyl group; m is 26 to 42; n is 4 to 12; m+n is 30 to 54; wherein the fatty alcohol alkoxylate of formula I has an average ethyleneoxy unit concentration per molecule, X, of >45 wt %; and, wherein the fatty alcohol alkoxylate of formula I has ratio, Z, equal to average ethyleneoxy unit concentration per molecule, X, divided by n; wherein ratio, Z, is <9.5. Also provided is a method of cleaning articles in an automatic dishwashing machine while maintaining cleanliness of the automatic dishwashing machine.

The present invention relates to automatic dishwashing compositions. In particular, the present invention relates to an automatic dishwashing composition including a maleic acid/olefin copolymer; a dispersant polymer, comprising a copolymer of acrylic acid and a sulfonated monomer; a builder; and a surfactant of formula I, wherein R¹ is a linear or branched, saturated C₈₋₂₄ alkyl group; R² is a linear saturated C₂₋₈ alkyl group; m is 26 to 42; n is 4 to 12; m+n is 30 to 54; wherein the fatty alcohol alkoxylate of formula I has an average ethyleneoxy unit concentration per molecule, X, of >45 wt %; and, wherein the fatty alcohol alkoxylate of formula I has ratio, Z, equal to average ethyleneoxy unit concentration per molecule, X, divided by n; wherein ratio, Z, is <9.5. The present invention also relates to a method of cleaning articles in an automatic dishwashing machine while maintaining cleanliness of the automatic dishwashing machine.

Automatic dishwashing compositions are generally recognized as a class of detergent compositions distinct from those used for fabric washing or water treatment. Automatic dishwashing compositions are expected by users to produce a spotless and film-free appearance on washed articles after a complete cleaning cycle.

A family of alcohol ethoxylates are disclosed by Burke et al. in U.S. Pat. No. 5,126,068 for use in streak free aqueous hard surface cleaning compositions. Burke et al. disclose cleaning composition containing, inter alia, an alcohol ethoxylate of the formula

RO(CH₂CH₂O)ₓ(CH₂CH(CH₃)O)_{y}(CH₂CH(CH₂CH₃)O)_{z}H

wherein R is an alkyl chain whose length is from 8 to 15 carbon atoms, x is a number from about 4 to 15, y is a number from about 0 to 15, and z is a number from about 0 to 5.

Notwithstanding phosphate-free compositions are increasingly desirable. Phosphate-free compositions rely on non-phosphate builders, such as salts of citrate, carbonate, bicarbonate, aminocarboxylates and others to sequester calcium and magnesium from hard water and block them from leaving an insoluble visible deposit on the dishware following drying. Phosphate-free compositions, however, have a greater tendency to leave spots on glassware and other surfaces.

Compositions that exhibit improved properties in automatic dishwashing and that are phosphate-free would be an advance in the industry. Accordingly, there remains a need for new surfactants having anti-spotting properties. In particular, there remains a need for new surfactants having anti-spotting properties that facilitate automatic dishwashing formulations that are both phosphate-free; anti-spotting and machine hygiene friendly.

The present invention provides an automatic dishwashing composition comprising: a maleic acid/olefin copolymer having a weight average molecular weight of 2,500 to 20,000 Daltons; a dispersant polymer, comprising a copolymer of acrylic acid and sulfonated monomer; a builder; and a surfactant, wherein the surfactant is a fatty alcohol alkoxylate of formula I:

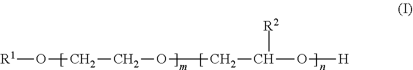

wherein R¹ is a linear or branched, saturated C₈₋₂₄ alkyl group; wherein R² is a linear saturated C₂₋₈ alkyl group; wherein m has an average value of 26 to 42; wherein n has an average value of 4 to 12; wherein m+n is an average value of 30 to 54; wherein the fatty alcohol alkoxylate of formula I has an average ethyleneoxy unit concentration per molecule, X, of >45 wt %; and, wherein the fatty alcohol alkoxylate of formula I has a ratio, Z, equal to the average ethyleneoxy unit concentration per molecule, X, divided by n; wherein the ratio, Z, is <9.5.

The present invention provides an automatic dishwashing composition comprising: a maleic acid/olefin copolymer having a weight average molecular weight of 2,500 to 20,000 Daltons; a dispersant polymer, wherein the dispersant polymer comprises a blend of (a) an acrylic acid homopolymer and (b) a copolymer of acrylic acid and a sulfonated monomer; wherein the blend has a blend weight ratio of (a) the acrylic acid homopolymer to (b) the copolymer of 3:1 to 1:3; a builder; and a surfactant, wherein the surfactant is a fatty alcohol alkoxylate of formula I, wherein R¹ is a linear or branched, saturated C₈₋₂₄ alkyl group; wherein R² is a linear saturated C₂₋₈ alkyl group; wherein m has an average value of 26 to 42; wherein n has an average value of 4 to 12; wherein m+n is an average value of 30 to 54; wherein the fatty alcohol alkoxylate of formula I has an average ethyleneoxy unit concentration per molecule, X, of >45 wt %; and, wherein the fatty alcohol alkoxylate of formula I has a ratio, Z, equal to the average ethyleneoxy unit concentration per molecule, X, divided by n; wherein the ratio, Z, is <9.5.

The present invention provides a method of cleaning an article in an automatic dishwashing machine while simultaneously maintaining the cleanliness of the automatic dishwashing machine, comprising: providing at least one food soiled article; providing an automatic dishwashing machine having a drain line with a non-metal strainer; providing water; selecting an automatic dishwashing composition according to the present invention, wherein the automatic dishwashing composition is specifically selected both for washing the food soiled article and for maintaining the cleanliness of the non-metal strainer by reducing the buildup of food soil on the non-metal strainer during use of the automatic dishwashing machine; applying the water and the automatic dishwashing composition to the at least one food soiled article forming a cleaned article and a food soiled water; and draining the food soiled water through the non-metal strainer.

### DETAILED DESCRIPTION

It has been surprisingly found that the automatic dishwashing compositions of the present invention, comprising: a maleic acid/olefin copolymer having a weight average molecular weight of 2,500 to 20,000 Daltons; a dispersant polymer, comprising a copolymer of acrylic acid and a sulfonated monomer; a builder; and a surfactant, wherein the surfactant is a fatty alcohol alkoxylate of formula I, wherein R¹ is a linear or branched, saturated C₈₋₂₄ alkyl group; wherein R² is a linear saturated C₂₋₈ alkyl group; wherein m has an average value of 26 to 42; wherein n has an average value of 4 to 12; wherein m+n is an average value of 30 to 54; wherein the fatty alcohol alkoxylate of formula I has an average ethyleneoxy unit concentration per molecule, X, of >45 wt %; and, wherein the fatty alcohol alkoxylate of formula I has a ratio, Z, equal to the average ethyleneoxy unit concentration per molecule, X, divided by n; wherein the ratio, Z, is <9.5; provide desirable article cleaning performance while simultaneously maintaining the cleanliness of the automatic dishwashing machine by resulting in a reduced mass of food waste collecting in the non-metallic strainer in the automatic dishwashing machine drain line. Given that most consumers would prefer not to have to be bothered with cleaning food waste from the non-metal strainers in the drain line from their automatic dishwashing machines and that the failure to maintain the cleanliness of the non-metal strainer may result in foul odors arising from putrefying food waste collected on the non-metal strainer; the automatic dishwashing composition of the present invention desirably facilitates cleaning of both (a) glassware, dishware and flatware; and (b) maintaining the cleanliness of the non-metal strainer by reducing the amount of food waste collecting on the non-metal strainer.

Unless otherwise indicated, ratios, percentages, parts, and the like are by weight. Weight percentages (or wt %) in the composition are percentages of dry weight, i.e., excluding any water that may be present in the composition. Percentages of monomer units in the polymer are percentages of solids weight, i.e., excluding any water present in a polymer emulsion.

As used herein, unless otherwise indicated, the terms “molecular weight” and “Mw” are used interchangeably to refer to the weight average molecular weight as measured in a conventional manner with gel permeation chromatography (GPC) and conventional standards, such as polyethylene glycol standards. GPC techniques are discussed in detail in Modem Size Exclusion Chromatography, W. W. Yau, J. J. Kirkland, D. D. Bly; Wiley-lnterscience, 1979, and in A Guide to Materials Characterization and Chemical Analysis, J. P. Sibilia; VCH, 1988, p. 81-84. Molecular weights are reported herein in units of Daltons.

The term “ethylenically unsaturated” is used to describe a molecule or moiety having one or more carbon-carbon double bonds, which renders it polymerizable. The term “ethylenically unsaturated” includes monoethylenically unsaturated (having one carbon-carbon double bond) and multi-ethylenically unsaturated (having two or more carbon-carbon double bonds). As used herein the term “(meth)acrylic” refers to acrylic or methacrylic.

The terms “Ethyleneoxy” and “EO” as used herein and in the appended claims refer to a —CH₂—CH₂—O— group.

The term “phosphate-free” as used herein and in the appended claims means compositions containing less than 0.5 wt % (preferably, less than 0.2 wt %; more preferably, less than 0.1 wt %; most preferably, less than the detectable limit) of phosphate (measured as elemental phosphorus).

The term “structural units” as used herein and in the appended claims refers to the remnant of the indicated monomer; thus a structural unit of acrylic acid is illustrated:

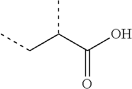

where the dotted lines represent the points of attachment to the polymer backbone.

Preferably, the automatic dishwashing composition of the present invention, comprises: a maleic acid/olefin copolymer having a weight average molecular weight of 2,500 to 20,000 Daltons (preferably, 5,000 to 18,000 Daltons; more preferably, 7,500 to 15,000 Daltons; most preferably, 9,000 to 13,000 Daltons); a dispersant polymer, comprising a copolymer of acrylic acid and sulfonated monomer; a builder; and a surfactant, wherein the surfactant is a fatty alcohol alkoxylate of formula I:

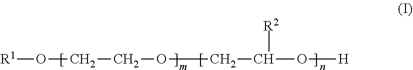

wherein R¹ is a linear or branched, saturated C₈₋₂₄ alkyl group (preferably, a linear or branched, saturated C₁₂₋₂₀ alkyl group; more preferably, wherein the linear or branched, saturated C₁₂₋₂₀ alkyl group is selected from the group consisting of a dodecyl group, a tetradecyl group, a hexadecyl group, an octadecyl group and an eicosyl group; most preferably, wherein the linear or branched, saturated C₁₂₋₂₀ alkyl group is selected from the group consisting of a hexadecyl group and an octadecyl); wherein R² is a linear saturated C₂₋₈ alkyl group (preferably, a linear saturated C₂₋₆ alkyl group; more preferably, a linear saturated C₂₋₄ alkyl group; most preferably, a C₂ alkyl group); wherein m has an average value of 26 to 42 (preferably, 29 to 33; more preferably, 30 to 32; most preferably, 30.5 to 31.5); wherein n has an average value of 4 to 12 (preferably, 5 to 11; more preferably, 6 to 9; most preferably, 7 to 8); wherein m+n is an average value of 30 to 54 (preferably, 34 to 44; more preferably, 36 to 41; most preferably, 37.5 to 39.5); wherein the fatty alcohol alkoxylate of formula I has an average ethyleneoxy unit concentration per molecule, X, of >45 wt % (preferably, ≥60 wt %; more preferably, 50 to 64.5 wt %; most preferably, 62 to 64 wt %); and, wherein the fatty alcohol alkoxylate of formula I has a ratio, Z, equal to X divided by n, wherein the ratio, Z, is <9.5 (preferably, 4 to 9.4; more preferably, 5 to 9.2; most preferably, 7.5 to 8.5). The surfactant may be a mixture of fatty alcohol alkoxylate compounds of formula I, wherein the surfactant is a mixture containing a range of alkyl groups R¹ and R² differing in carbon number, but having average carbon numbers that conform to the ranges described above.

Preferably, the automatic dishwashing composition of the present invention, comprises: a maleic acid/olefin copolymer having a weight average molecular weight of 2,500 to 20,000 Daltons (preferably, 5,000 to 18,000 Daltons; more preferably, 7,500 to 15,000 Daltons; most preferably, 9,000 to 13,000 Daltons); dispersant polymer, comprising a blend of (a) an acrylic acid homopolymer and (b) a copolymer of acrylic acid and a sulfonated monomer, wherein the blend has a blend weight ratio of (a) the acrylic acid homopolymer to (b) the copolymer of 3:1 to 1:3 (preferably, 2.5:1 to 1:2.5; more preferably, 2:1 to 1:2; most preferably, 1.5:1 to 1:1.5); a builder; and a surfactant, wherein the surfactant is a fatty alcohol alkoxylate of formula I, wherein R¹ is a linear or branched, saturated C₈₋₂₄ alkyl group (preferably, a linear or branched, saturated C₁₂₋₂₀ alkyl group; more preferably, wherein the linear or branched, saturated C₁₂₋₂₀ alkyl group is selected from the group consisting of a dodecyl group, a tetradecyl group, a hexadecyl group, an octadecyl group and an eicosyl group; most preferably, wherein the linear or branched, saturated C₁₂₋₂₀ alkyl group is selected from the group consisting of a hexadecyl group and an octadecyl); wherein R² is a linear saturated C₂₋₈ alkyl group (preferably, a linear saturated C₂₋₆ alkyl group; more preferably, a linear saturated C₂₋₄ alkyl group; most preferably, a C₂ alkyl group); wherein m has an average value of 26 to 42 (preferably, 29 to 33; more preferably, 30 to 32; most preferably, 30.5 to 31.5); wherein n has an average value of 4 to 12 (preferably, 5 to 11; more preferably, 6 to 9; most preferably, 7 to 8); wherein m+n is an average value of 30 to 54 (preferably, 34 to 44; more preferably, 36 to 41; most preferably, 37.5 to 39.5); wherein the fatty alcohol alkoxylate of formula I has an average ethyleneoxy unit concentration per molecule, X, of >45 wt % (preferably, >60 wt %; more preferably, 50 to 64.5 wt %; most preferably, 62 to 64 wt %); and, wherein the fatty alcohol alkoxylate of formula I has a ratio, Z, equal to X divided by n, wherein the ratio, Z, is <9.5 (preferably, 4 to 9.4; more preferably, 5 to 9.2; most preferably, 7.5 to 8.5). The surfactant may be a mixture of fatty alcohol alkoxylate compounds of formula I, wherein the surfactant is a mixture containing a range of alkyl groups R¹ and R² differing in carbon number, but having average carbon numbers that conform to the ranges described above.

Preferably, the automatic dishwashing composition of the present invention, comprises (i) a maleic acid/olefin copolymer and (ii) a surfactant, wherein the surfactant is a fatty alcohol alkoxylate of formula I; wherein the weight ratio of (i) the maleic acid/olefin copolymer to (ii) the fatty alcohol alkoxylate of formula I is <10:1 (preferably, 1:1 to 10:1; more preferably, 3:1 to 9:1; most preferably, 6.5:1 to 8.5:1).

Preferably, the automatic dishwashing composition of the present invention, comprises a maleic acid/olefin copolymer. More preferably, the automatic dishwashing composition of the present invention, comprises 0.1 to 2 wt % (preferably, 0.2 to 1.5 wt %; more preferably, 0.25 to 1 wt %; most preferably, 0.4 to 0.6 wt %), based on the dry weight of the automatic dishwashing composition, of a maleic acid/olefin copolymer. Still more preferably, the automatic dishwashing composition of the present invention, comprises 0.1 to 2 wt % (preferably, 0.2 to 1.5 wt %; more preferably, 0.25 to 1 wt %; most preferably, 0.4 to 0.6 wt %), based on the dry weight of the automatic dishwashing composition, of a maleic acid/olefin copolymer, wherein the maleic acid/olefin copolymer is a copolymer of maleic acid and di-isobutylene. Most preferably, the automatic dishwashing composition of the present invention, comprises 0.1 to 2 wt % (preferably, 0.2 to 1.5 wt %; more preferably, 0.25 to 1 wt %; most preferably, 0.4 to 0.6 wt %), based on the dry weight of the automatic dishwashing composition, of a maleic acid/olefin copolymer; wherein the maleic acid/olefin copolymer is a copolymer of maleic acid and di-isobutylene and wherein the maleic acid/olefin copolymer has a weight average molecular weight, Mw, of 2,500 to 20,000 Daltons (preferably, 5,000 to 18,000 Daltons; more preferably, 7,500 to 15,000 Daltons; most preferably, 9,000 to 13,000 Daltons).

The maleic acid/olefin copolymer may be in the form of a water-soluble solution polymer, slurry, dried powder, or granules or other solid forms.

Preferably, the automatic dishwashing composition of the present invention, comprises a dispersant polymer. More preferably, the automatic dishwashing composition of the present invention, comprises 0.5 to 15 wt % (preferably, 0.5 to 10 wt %; more preferably, 1 to 8 wt %; most preferably, 2.5 to 7.5 wt %), based on the dry weight of the automatic dishwashing composition, of a dispersant polymer. Still more preferably, the automatic dishwashing composition of the present invention, comprises 0.5 to 15 wt % (preferably, 0.5 to 10 wt %; more preferably, 1 to 8 wt %; most preferably, 2.5 to 7.5 wt %), based on the dry weight of the automatic dishwashing composition, of a dispersant polymer; wherein the dispersant polymer comprises a copolymer of acrylic acid and a sulfonated monomer. Most preferably, the automatic dishwashing composition of the present invention, comprises 0.5 to 15 wt % (preferably, 0.5 to 10 wt %; more preferably, 1 to 8 wt %; most preferably, 2.5 to 7.5 wt %), based on the dry weight of the automatic dishwashing composition, of a dispersant polymer; wherein the dispersant polymer is a blend of (a) an acrylic acid homopolymer and (b) a copolymer of acrylic acid and a sulfonated monomer; wherein the blend has a blend weight ratio of (a) the acrylic acid homopolymer to (b) the copolymer of 3:1 to 1:3 (preferably, 2.5:1 to 1:2.5; more preferably, 2:1 to 1:2; most preferably, 1.5:1 to 1:1.5);

Preferably, the automatic dishwashing composition of the present invention, comprises ≥1 wt % (more preferably, ≥2 wt %; more preferably, ≥3 wt %; more preferably, ≥4 wt %) of the dispersant polymer, based on the dry weight of the automatic dishwashing composition. Preferably, the automatic dishwashing composition of the present invention, comprises ≤10 wt % (more preferably, ≤8 wt %; more preferably, ≤6 wt %; more preferably, ≤5 wt %) of the dispersant polymer, based on the dry weight of the automatic dishwashing composition.

Preferably, the dispersant polymer is a blend of (a) a copolymer of acrylic acid and (b) a sulfonated monomer; wherein the blend has a blend weight ratio of (a) the acrylic acid homopolymer to (b) the copolymer of 3:1 to 1:3 (preferably, 2.5:1 to 1:2.5; more preferably, 2:1 to 1:2; most preferably, 1.5:1 to 1:1.5), based on weight.

Preferably, the copolymer of acrylic acid and a sulfonated monomer, has a weight average molecular weight, Mw, of 2,000 to 100,000 Daltons (preferably, 5,000 to 60,000 Daltons; more preferably, 8,000 to 25,000 Daltons; still more preferably, 10,000 to 20,000 Daltons; most preferably, 12,500 to 17,500 Daltons).

Preferably, the copolymer of acrylic acid and a sulfonated monomer, comprises structural units of at least one sulfonated monomer. More preferably, the copolymer of acrylic acid and a sulfonated monomer, comprises structural units of at least one sulfonated monomer selected from the group consisting of 2-acrylamido-2-methylpropane sulfonic acid (AMPS), 2-methacrylamido-2-methylpropane sulfonic acid, 4-styrenesulfonic acid, vinylsulfonic acid, 3-allyloxy sulfonic acid, 2-hydroxy-1-propane sulfonic acid (HAPS), 2-sulfoethyl(meth)acrylic acid, 2-sulfopropyl(meth)acrylic acid, 3-sulfopropyl(meth)acrylic acid, 4-sulfobutyl(meth)acrylic acid and salts thereof.

Preferably, the copolymer of acrylic acid and a sulfonated monomer, comprises: 5 to 65 wt % (more preferably, 15 to 40 wt %; most preferably, 20 to 35 wt %) of acrylic acid structural units.

Preferably, the copolymer of acrylic acid and a sulfonated monomer, comprises: 50 to 95 wt % (preferably, 70 to 93 wt %) of structural units of acrylic acid and 5 to 50 wt % (preferably, 7 to 30 wt %) of structural units of 2-acrylamido-2-methylpropane sulfonic acid sodium salt. More preferably, the copolymer of acrylic acid and a sulfonated monomer, comprises: 50 to 95 wt % (preferably, 70 to 93 wt %) of structural units of acrylic acid and 5 to 50 wt % (preferably, 7 to 30 wt %) of structural units of 2-acrylamido-2-methylpropane sulfonic acid sodium salt; wherein the copolymer has a weight average molecular weight, Mw, of 2,000 to 100,000 Daltons (more preferably, 10,000 to 20,000 Daltons; most preferably, 12,500 to 17,500 Daltons).

Preferably, the acrylic acid homopolymer, has a weight average molecular weight, Mw, of 1,000 to 20,000 Daltons (preferably, 1,000 to 15,000 Daltons; more preferably, 1,000 to 10,000 Daltons; still more preferably, 1,500 to 4,000 Daltons; most preferably, 1,750 to 3,000 Daltons).

The polymers included as dispersant polymers used in the automatic dishwashing composition of the present invention are commercially available from various sources, and/or they may be prepared using literature techniques. For instance, low-molecular weight dispersant polymers may be prepared by free-radical polymerization. A preferred method for preparing these polymers is by homogeneous polymerization in a solvent. The solvent may be water or an alcoholic solvent such as 2-propanol or 1,2-propanediol. The free-radical polymerization is initiated by the decomposition of precursor compounds such as alkali persulfates or organic peracids and peresters. The activation of the precursors may be by the action of elevated reaction temperature alone (thermal activation) or by the admixture of redox-active agents such as a combination of iron(II) sulfate and ascorbic acid (redox activation). In these cases, a chain-transfer agent is typically used to modulate polymer molecular weight. One class of preferred chain-transfer agents employed in solution polymerizations is the alkali or ammonium bisulfites. Specifically mentioned is sodium meta-bisulfite.

The polymers included as dispersant polymers used in the automatic dishwashing composition of the present invention may be in the form of a water-soluble solution polymer, slurry, dried powder, or granules or other solid forms.

Preferably, the automatic dishwashing composition of the present invention, comprises a builder. More preferably, the automatic dishwashing composition of the present invention comprises 10 to 99.2 wt % (preferably, 25 to 90 wt %; more preferably, 40 to 80 wt %; most preferably, 50 to 70 wt %), based on the dry weight of the automatic dishwashing composition, of the builder. Weight percentages of carbonates or citrates are based on the actual weights of the salts, including the metal ions.

Preferably, builder used in the automatic dishwashing composition of the present invention, comprises one or more carbonates or citrates. The term “carbonate(s)” as used herein and in the appended claims refers to alkali metal or ammonium salts of carbonate, bicarbonate and/or sesquicarbonate. The term “citrate(s)” as used herein and in the appended claims refers to alkali metal citrates. Preferably, builder used in the automatic dishwashing composition of the present invention, comprises one or more carbonates or citrates; wherein the carbonates and citrates are selected from the group consisting of carbonate and citrate salts of sodium, potassium and lithium (more preferably, sodium or potassium; most preferably, sodium salts). More preferably, builder used in the automatic dishwashing composition of the present invention is selected from the group consisting of sodium carbonate, sodium bicarbonate, sodium citrate, and mixtures thereof.

Preferably, the automatic dishwashing composition of the present invention, comprises a surfactant. More preferably, the automatic dishwashing composition of the present invention, comprises 0.2 to 10 wt % (preferably, 2.0 to 5 wt %; more preferably, 3 to 4 wt %; most preferably, 3.25 to 3.75 wt %), based on the dry weight of the automatic dishwashing composition, of a surfactant. Most preferably, the automatic dishwashing composition of the present invention, comprises 0.2 to 10 wt % (preferably, 2.0 to 5 wt %; more preferably, 3 to 4 wt %; most preferably, 3.25 to 3.75 wt %), based on the dry weight of the automatic dishwashing composition, of a surfactant; wherein the surfactant is a fatty alcohol alkoxylate of formula I, wherein each R¹ is a linear or branched, saturated C₈₋₂₄ alkyl group (preferably, a linear or branched, saturated C₁₂₋₂₀ alkyl group; more preferably, wherein the linear or branched, saturated C₁₂₋₂₀ alkyl group is selected from the group consisting of a dodecyl group, a tetradecyl group, a hexadecyl group, an octadecyl group and an eicosyl group; most preferably, wherein the linear or branched, saturated C₁₂₋₂₀ alkyl group is selected from the group consisting of a hexadecyl group and an octadecyl group); wherein R² is a linear saturated C₂₋₈ alkyl group (preferably, a linear saturated C₂₋₆ alkyl group; more preferably, a linear saturated C₂₋₄ alkyl group; most preferably, a C₂ alkyl group); wherein m has an average value of 26 to 42 (preferably, 29 to 33; more preferably, 30 to 32; most preferably, 30.5 to 31.5); wherein n has an average value of 4 to 12 (preferably, 5 to 11; more preferably, 6 to 9; most preferably, 7 to 8); wherein m+n is an average value of 30 to 54 (preferably, 34 to 44; more preferably, 36 to 41; most preferably, 37.5 to 39.5); wherein the fatty alcohol alkoxylate of formula I has an average ethyleneoxy unit concentration per molecule, X, of >45 wt % (preferably, >60 wt %; more preferably, 50 to 64.5 wt %; most preferably, 62 to 64 wt %); and, wherein the fatty alcohol alkoxylate of formula I has a ratio, Z, equal to X divided by n, wherein the ratio, Z, is <9.5 (preferably, 4 to 9.4; more preferably, 5 to 9.2; most preferably, 7.5 to 8.5). Preferably, the surfactant may be a mixture of fatty alcohol alkoxylate compounds of formula I, wherein the surfactant is a mixture containing a range of alkyl groups R¹ and R² differing in carbon number, but having average carbon numbers that conform to the ranges described above. Preferably, the surfactant is a mixture of fatty alcohol alkoxylate compounds of formula I, wherein the surfactant is a mixture containing two different alkyl groups R¹. More preferably, the surfactant is a mixture of fatty alcohol alkoxylate compounds of formula I, wherein the surfactant is a mixture containing two different alkyl groups R¹, wherein the two different alkyl groups R¹ are hexadecyl groups and octadecyl groups.

The surfactant fatty alcohol alkoxylate of formula I in the automatic dishwashing composition of the present invention can be readily prepared using known synthetic procedures. For instance, a typical procedure for preparing the compounds is as follows. An alcohol conforming to the formula R¹OH (wherein R¹ is a linear or branched, saturated C₈₋₂₄ alkyl group) is added to a reactor, and heated in the presence of a base (for example, sodium hydride, sodium methoxide or potassium hydroxide). The mixture should be relatively free of water. To this mixture is then added the desired amount of ethylene oxide, EO, under pressure. After the EO has been consumed (as indicated by a substantial fall in reactor pressure), the resulting ethoxylated alcohol can be subjected to reaction with an alkylene oxide (wherein the alkylene oxide contains from 4 to 10 carbon atoms) at a molar ratio of ethoxylated alcohol to alkylene oxide of 1:4 to 1:12 under basic conditions. The molar ratio of catalyst to ethoxylated alcohol can be between 0.01:1 and 1:1 (preferably, 0.02:1 to 0.5:1). The reaction to form the ethoxylated alcohol and the further reaction with the alkylene oxide are typically conducted in the absence of solvent and at temperatures of 25 to 200° C. (preferably, 80 to 160° C.).

The automatic dishwashing composition of the present invention, optionally further comprises: an additive. Preferably, the automatic dishwashing composition of the present invention, optionally further comprises: an additive selected from the group consisting of an alkaline source; a bleaching agent (e.g., sodium percarbonate, sodium perborate); a bleach activator (e.g., tetraacetylethylenediamine (TAED)); a bleach catalyst (e.g., manganese(II) acetate, or cobalt(II) chloride); an enzyme (e.g., protease, amylase, lipase, or cellulase); an aminocarboxylate chelant (e.g., methylglycinediacetic acid (MGDA), glutamic acid-N,N-diacetic acid (GLDA), iminodisuccinic acid (IDSA), 1,2-ethylenediamine disuccinic acid (EDDS), aspartic acid diacetic acid (ASDA), salts thereof, and mixtures thereof); a phosphonate (e.g., 1-hydroxy ethylidene-1,1-diphosphonic acid (HEDP)); foam suppressants; dyes; fragrances; silicates; additional builders; antibacterial agents; fillers (e.g., sodium sulfate); and mixtures thereof. Fillers used in automatic dishwashing compositions provided in tablet or powder form include inert, water-soluble substances, typically sodium or potassium salts (e.g., sodium sulfate, potassium sulfate, sodium chloride, potassium chloride) and are typically provided in amounts ranging up to 75 wt % of the automatic dishwashing composition. Fillers used in automatic dishwashing compositions provided in gel form include water in addition to those mentioned above for use in tablet and powder automatic dishwashing compositions. Fragrances, dyes, foam suppressants, enzymes and antibacterial agents used in automatic dishwashing compositions typically account for ≤10 wt % (preferably, ≤5 wt %) of the automatic dishwashing composition.

The automatic dishwashing composition of the present invention, optionally further comprises: an alkaline source. Suitable alkaline sources include, without limitation, alkali metal carbonates and alkali metal hydroxides (e.g., sodium and potassium carbonate, bicarbonate, sesquicarbonate, sodium, lithium, and potassium hydroxide) and mixtures thereof. Sodium carbonate is preferred. Preferably, the automatic dishwashing composition of the present invention comprises 1 to 80 wt % (preferably, 20 to 60 wt %) of an alkaline source (preferably, wherein the alkaline source is sodium carbonate) based on the dry weight of the automatic dishwashing composition.

The automatic dishwashing composition of the present invention, optionally further comprises: a bleaching agent. Preferably, the automatic dishwashing composition of the present invention comprises 1 to 30 wt % (preferably, 8 to 20 wt %) of a bleaching agent, based on the dry weight of the automatic dishwashing composition.

Preferably, the automatic dishwashing composition of the present invention, comprises: sodium carbonate; sodium bicarbonate; sodium citrate; a bleaching agent (preferably, wherein the bleaching agent is sodium percarbonate); a bleaching activator (preferably, wherein the bleaching activator is TAED); a surfactant, wherein the surfactant is a fatty alcohol alkoxylate of formula I as described above; an enzyme (preferably, wherein the enzyme is selected from the group consisting of a protease, an amylase, and mixtures thereof); a maleic acid/olefin copolymer; a dispersant polymer, wherein the dispersant polymer is a blend of (a) a homopolymer of acrylic acid and (b) a copolymer of acrylic acid and AMPS (or a salt of AMPS); a phosphonate (preferably, wherein the phosphonate is HEDP); and, optionally, a filler (preferably, wherein the filler is sodium sulfate).

Preferably, the automatic dishwashing composition of the present invention, comprises: 10 to 50 wt % (preferably, 15 to 30 wt %; more preferably, 15 to 25 wt %) sodium carbonate; 5 to 50 wt % (preferably, 10 to 40 wt %; more preferably, 25 to 35 wt %) of sodium citrate; 5 to 25 wt % (preferably, 10 to 20 wt %) of a bleaching agent (preferably, wherein the bleaching agent is sodium percarbonate); 1 to 6 wt % (preferably, 2 to 5 wt %) of a bleaching activator (preferably, wherein the bleaching activator is TAED); 0.2 to 15 wt % (preferably, 0.5 to 10 wt %; more preferably, 2 to 7.5 wt %) of a surfactant, wherein the surfactant is a fatty alcohol alkoxylate of formula I as described above; 0.1 to 2 wt % (preferably, 0.2 to 1.5 wt %; more preferably, 0.25 to 1 wt %; most preferably, 0.4 to 0.6 wt %) of a maleic acid/olefin copolymer; 0.5 to 15 wt % (preferably, 0.5 to 10 wt %; more preferably, 1 to 8 wt %; most preferably, 2.5 to 7.5 wt %) of a dispersant polymer, wherein the dispersant polymer is a blend of (a) a homopolymer of acrylic acid and (b) a copolymer of acrylic acid and AMPS (or a salt of AMPS); 1 to 6 wt % (preferably, 2 to 4 wt %) of an enzyme (preferably, wherein the enzyme is selected from the group consisting of a protease, an amylase and mixtures thereof; more preferably, wherein the enzyme is a mixture of a protease and an amylase); and 1 to 10 wt % (preferably, 2 to 7.5 wt %) of a filler (preferably, wherein the filler is sodium sulfate); wherein each wt % is based on the dry weight of the automatic dishwashing composition.

Preferably, the automatic dishwashing composition of the present invention has a pH (at 1 wt % in distilled water) of at least 9 (preferably, >10). Preferably, the automatic dishwashing composition of the present invention has a pH (at 1 wt % in distilled water) of no greater than 13.

Preferably, the automatic dishwashing composition of the present invention can be formulated in any typical form, e.g., as a tablet, powder, block, monodose, sachet, paste, liquid or gel. The automatic dishwashing compositions of the present invention are useful for cleaning ware, such as eating and cooking utensils, dishes, in an automatic dishwashing machine.

Preferably, the automatic dishwashing composition of the present invention can be used under typical operating conditions. For instance, when used in an automatic dishwashing machine, typical water temperatures during the washing process preferably are from 20° C. to 85° C., preferably 30° C. to 70° C. Typical concentrations for the automatic dishwashing composition as a percentage of total liquid in the dishwasher preferably are from 0.1 to 1 wt %, preferably from 0.2 to 0.7 wt %. With selection of an appropriate product form and addition time, the automatic dishwashing compositions of the present invention may be present in the prewash, main wash, penultimate rinse, final rinse, or any combination of these cycles.

Preferably, the automatic dishwashing composition of the present invention comprises <0.5 wt % (preferably, <0.2 wt %; more preferably, <0.1 wt %; still more preferably, <0.01 wt %; most preferably, <the detectable limit) of phosphate (measured as elemental phosphorus). Preferably, the automatic dishwashing composition of the present invention is phosphate free.

Preferably, the automatic dishwashing composition of the present invention comprises <0.5 wt % (preferably, <0.2 wt %; more preferably, <0.1 wt %; still more preferably, <0.01 wt %; most preferably, <the detectable limit) in total of aminocarboxylate chelants. More preferably, the automatic dishwashing composition of the present invention comprises <0.5 wt % (preferably, <0.2 wt %; more preferably, <0.1 wt %; still more preferably, <0.01 wt %; most preferably, <the detectable limit) in total of aminocarboxylate chelants including methylglycinediacetic acid (MGDA), glutamic acid-N,N-diacetic acid (GLDA), iminodisuccinic acid (IDSA), 1,2-ethylenediamine disuccinic acid (EDDS) and aspartic acid diacetic acid (ASDA). Preferably, the automatic dishwashing composition of the present invention comprises <0.5 wt % (preferably, <0.2 wt %; more preferably, <0.1 wt %; still more preferably, <0.01 wt %; most preferably, <the detectable limit) of methylglycinediacetic acid (MGDA). Preferably, the automatic dishwashing composition of the present invention is aminocarboxylate chelant free. Preferably, the automatic dishwashing composition of the present invention is methylglycinediacetic acid (MGDA) free.

Preferably, in the method of cleaning an article in an automatic dishwashing machine while simultaneously maintaining the cleanliness of the automatic dishwashing machine of the present invention, comprises: providing at least one food soiled article (e.g., glass tumblers, wine glasses, stainless steel plates, polyethylene containers); providing an automatic dishwashing machine having a drain line with a non-metal strainer (preferably, a plastic strainer); providing water; selecting an automatic dishwashing composition according to the present invention, wherein the automatic dishwashing composition is specifically selected both for washing the food soiled article and for maintaining the cleanliness of the non-metal strainer by reducing the buildup of food soil on the non-metal strainer during use of the automatic dishwashing machine; applying the water and the automatic dishwashing composition to the at least one food soiled article forming a cleaned article and a food soiled water; and draining the food soiled water through the non-metal strainer.

Some embodiments of the present invention will now be described in detail in the following Examples.

### Comparative Example C1 and Example 1: Alkoxylated Surfactants

The alkoxylation reactions were carried out in a 2-L 316 stainless steel conical bottom (minimum stirring volume 20 mL) Parr reactor, model 4530, equipped with a ¼ hp magnetic drive agitator, 1500 watt (115V) Calrod electric heater, ¼ inch water filled cooling coil, 1/16 inch dip tube for sampling, internal thermowell, ¼ inch rupture disc set at 1024 psig, ¼ inch relief valve set at 900 psig, an oxide addition line submerged below the liquid level, and a 2 inch diameter pitch-blade agitator. The bottom of the agitator shaft had a custom-made stainless steel paddle shaped to the contour of the reactor to allow stirring at very low initial volumes. The oxide addition system consisted of a 1 liter stainless steel addition cylinder, which was charged, weighed, and attached to the oxide load line. The reactor system was controlled by a Siemens SIMATIC PCS7 process control system. Reaction temperatures were measured with Type K thermocouples, pressures were measured with Ashcroft pressure transducers, ball valves were operated with Swagelok pneumatic valve actuators, cooling water flow was controlled with ASCO electric valves, and oxide addition rates were controlled by a mass flow control system consisting of a Brooks Quantim® Coriolis mass flow controller (model QMBC3L1B2A1A1A1DH1C7A1DA) and a TESCOM back pressure regulator (model 44-1163-24-109A) which maintained a 100 psig pressure differential across the mass flow controller to afford steady flow rates.

In each of Comparative Example C1 and Example 1, an alkoxylation reaction was performed in the 2-L 316 stainless steel conical bottom (minimum stirring volume 20 mL) Parr reactor, wherein the Parr reactor was charged with a quantity of the initiator with a basic alkoxylation catalyst in the concentration as noted in TABLE 1, purged with nitrogen for one hour and heated to 120 to 130° C. before the addition of ethylene oxide (EO). Then ethylene oxide (EO) was charged to the Parr reactor at a rate of 0.5 to 3 g/min to provide the molar ratio of EO to initiator noted in TABLE 1. After the pressure in the Parr reactor stabilized, propylene oxide (PO) (if any) and butylene oxide (BO) (if any) were charged to the Parr reactor at a rate of 0.5 to 2 g/min to provide the molar ratio of PO to initiator and BO to initiator noted in TABLE 1. The Parr reactor was then held at 120 to 130° C. overnight before cooling to 50° C. to recover the product surfactant for use in automatic dishwashing tests described hereinbelow.

TABLE 1

| | | | Mol/mol | | | | |
|---|---|---|---|---|---|---|---|
| | | Catalyst | initiator | | [EO] (wt %), | | |
| Ex. | Initiator, I | (wt % in I)^{A} | EO, m | BO, n | X | [EO]/n, Z | m + n |
| C1 | B | 0.66 | 25 | 7 | 59.68 | 8.53 | 38.8 |
| 1 | B | 0.61 | 31 | 7.8 | 63.01 | 8.08 | 32 |

^{A}Potassium hydroxide (≥85%) available from Sigma-Aldrich
^{B} 50:50 wt % mixture of hexadecanol and octadecanol (Nafol ® 1618H linear alcohol mixture available from Sasol)

### Procedure for Preparing Food Soil

The food soil formulation described in TABLE 2 was prepared by heating water to 70° C. and then adding the potato starch, quark powder, benzoic acid and margarine. Agitating until the margarine was well dissolved. Then adding the milk and agitating well. Letting the resulting mixture cool down. Then, when the temperature falls below 45° C., adding the egg yolks, ketchup and mustard. Mixing well and then freezing the resulting food soil formulations in 50 g aliquots for used in the automatic dishwashing tests.

TABLE 2

| | Concentration in food soil |
|---|---|
| Ingredient | formulation wt % |
| water | 71.1 |
| margarine | 10.2 |
| potato starch | 0.5 |
| Quark powder | 2.5 |
| benzoic acid | 0.1 |
| milk | 5.1 |
| egg yolks | 5.5 |
| ketchup | 2.5 |
| mustard | 2.5 |

### Comparative Examples CF1-CF6 and Examples F1-F6: Dishwashing Formulations

Dishwashing compositions containing commercial surfactant, surfactant prepared according to Comparative Example C1 or Example 1 above were provided using the component formulation identified in one of TABLE 3. The protease used in each of the component formulations was Savinase® 12T protease available from Novozymes. The amylase used in each of the component formulations was Stainzyme® 12T amylase available from Novozymes.

TABLE 3

| | Concentration in Dishwashing Formulation on solids basis (wt %) | | | | | | | | | | | |
|---|---|---|---|---|---|---|---|---|---|---|---|---|
| Ingredient | CF1 | CF2 | CF3 | CF4 | CR5 | CF6 | CF7 | F1 | F2 | F3 | F4 | F5 |
| sodium citrate | 30 | 30 | 30 | 30 | 30 | 30 | 30 | 30 | 30 | 30 | 30 | 30 |
| sodium | 20 | 20 | 20 | 20 | 20 | 20 | 20 | 20 | 20 | 20 | 20 | 20 |
| carbonate | | | | | | | | | | | | |
| sodium | 10 | 10 | 10 | 10 | 10 | 10 | 10 | 10 | 10 | 10 | 10 | 10 |
| bicarbonate | | | | | | | | | | | | |
| percarbonate | 15 | 15 | 15 | 15 | 15 | 15 | 15 | 15 | 15 | 15 | 15 | 15 |
| TAED | 4 | 4 | 4 | 4 | 4 | 4 | 4 | 4 | 4 | 4 | 4 | 4 |
| Comp. Ex. C1 | — | — | — | — | — | 3.5 | 3.5 | — | — | — | — | — |
| Example 1 | 3.5 | — | — | — | 3.5 | — | — | 3.5 | 3.5 | 3.5 | 2.5 | 2.5 |
| Surfactant^{a} | — | — | 3.5 | 3.5 | — | — | — | — | — | — | — | — |
| Copolymer^{b} | — | 1 | — | 1 | — | — | 0.3 | 0.5 | 1 | 0.3 | 0.5 | 0.3 |
| dispersant^{c} | 5 | 5 | 5 | 5 | 5 | 5 | 5 | 5 | 5 | 5 | 5 | 5 |
| protease | 2 | 2 | 2 | 2 | 2 | 2 | 2 | 2 | 2 | 2 | 2 | 2 |
| amylase | 1 | 1 | 1 | 1 | 1 | 1 | 1 | 1 | 1 | 1 | 1 | 1 |
| HEDF^{d} | 2 | 2 | 2 | 2 | 2 | 2 | 2 | 2 | 2 | 2 | 2 | 2 |
| sodium sulfate | 7.5 | 10 | 7.5 | 6.5 | 7.5 | 7.5 | 7.2 | 7 | 6.5 | 7.2 | 8 | 8.2 |

^{a}DOWFAX ™ 20B102 linear alcohol alkoxylate available from The Dow Chemical Company
^{b}Acusol ™ 460N copolymer of maleic acid and di-isobutylene available from The Dow Chemical Company
^{c}50:50 wt % mixture of Acusol ™ 588 detergent polymer and Acusol ™ 902N dispersant polymer available from The Dow Chemical Company
^{d}Dequest 2016DG phosphonate available from Italmatch Chemicals

### Dishwashing Test Conditions

The dishwashing test conditions used with the Dishwashing formulations of Comparative Examples CF1-CF4 and Examples F1-F2 dosed at 20 g per wash were as follows: Machine: Miele SS-ADW, Model G1223SC L2. Program: V4, 50° C. wash cycle with heated wash for 8 min, fuzzy logic disengaged, heated dry. Water: 380 ppm hardness (as CaCO₃, confirmed by EDTA titration), Ca:Mg=3:1, 250 ppm sodium carbonate. Food soil: 50 g of the composition noted in TABLE 2 were introduced at t=0, frozen in a cup.

The dishwashing test conditions used with the Dishwashing formulations of Comparative Examples CF5-CF7 and Examples F3-F5 dosed at 20 g per wash were as follows: Machine: Miele SS-ADW, Model G1222SC Labor. Program: V4, 50° C. wash cycle with heated wash for 8 min, fuzzy logic disengaged, heated dry. Water: 390 ppm hardness (as CaCO₃, confirmed by EDTA titration), Ca:Mg=3:1, 250 ppm sodium carbonate. Food soil: 50 g of the composition noted in TABLE 2 were introduced at t=0, frozen in a cup.

### Filming and Spotting Evaluation

After drying in open air filming and spotting ratings were determined by trained evaluators by observations of glass tumblers in a light box with controlled illumination from below. Glass tumblers, wine glasses, stainless steel plates and polyethylene containers were rated for filming and spotting according to ASTM method ranging from 1 (no film/spots) to 5 (heavily filmed/spotted). An average value of 1 to 5 for filming and spotting was determined for the glass tumblers, wine glasses, stainless steel plates and polyethylene containers are reported in TABLE 4, respectively, following 10 wash cycles. The non-metal strainer in the drain line from the dishwashing machines were weighed before the first wash cycle and after the 10^{th} wash cycle for each dishwashing composition to determine the amount of waste collected on the strainer. The results are provided in TABLE 5.

TABLE 4

| | Rating | | | | | | | |
|---|---|---|---|---|---|---|---|---|
| Dishwashing | Tumbler | | Wine Glass | | SS Plate | | PP Container | |
| Composition | Spot | Film | Spot | Film | Spot | Film | Spot | Film |
| Comp. Example CF1 | 2.0 | 2.5 | 2.0 | 2.0 | 1.0 | 2.0 | — | — |
| Comp. Example CF2 | 5.0 | 2.0 | 5.0 | 1.5 | 5.0 | 1.5 | — | — |
| Comp. Example CF3 | 5.0 | 1.0 | 5.0 | 1.0 | 2.0 | 2.0 | — | — |
| Comp. Example CF4 | 5.0 | 1.0 | 5.0 | 1.0 | 5.0 | 1.5 | — | — |
| Comp. Example CF5 | 2.0 | 3.0 | 2.0 | 2.0 | 1.0 | 1.5 | 1.0 | 3.0 |
| Comp. Example CF6 | 3.0 | 2.0 | 2.0 | 1.5 | 2.0 | 2.0 | 1.0 | 2.0 |
| Comp. Example CF7 | 5.0 | 1.5 | 4.0 | 1.0 | 4.0 | 1.0 | 1.0 | 2.0 |
| Example F1 | 2.0 | 2.0 | 1.5 | 2.5 | 2.0 | 2.5 | — | — |
| Example F2 | 2.0 | 2.5 | 1.5 | 2.5 | 3.0 | 3.0 | — | — |
| Example F3 | 2.0 | 3.0 | 2.0 | 1.5 | 1.5 | 1.5 | 1.0 | 3.5 |
| Example F4 | 2.0 | 2.5 | 2.0 | 2.0 | 2.0 | 2.0 | 1.0 | 2.0 |
| Example F5 | 2.0 | 2.5 | 2.0 | 1.5 | 1.0 | 1.5 | 1.0 | 2.0 |

TABLE 5

| Dishwashing | Filter Weight (in g) | | Residue |
|---|---|---|---|
| Composition | Before 1^{st} Cycle | After 10^{th} Cycle | collected (in g) |
| Comp. Example CF1 | 196.87 | 198.35 | 1.54 |
| Comp. Example CF2 | 195.89 | 197.36 | 1.47 |
| Comp. Example CF3 | 196.91 | 197.2 | 0.29 |
| Comp. Example CF4 | 195.5 | 195.71 | 0.21 |
| Comp. Example CF5 | 195.27 | 197.49 | 2.22 |
| Comp. Example CF6 | 195.45 | 196.43 | 0.98 |
| Comp. Example CF7 | 198.91 | 199.36 | 0.45 |
| Example F1 | 196.83 | 197.71 | 0.88 |
| Example F2 | 197.7 | 198.68 | 0.98 |
| Example F3 | 198.94 | 200.82 | 1.88 |
| Example F4 | 195.16 | 196.24 | 1.08 |
| Example F5 | 195.98 | 196.85 | 0.87 |

We claim:

1. An automatic dishwashing composition comprising:
a maleic acid/olefin copolymer having a weight average molecular weight of 2,500 to 20,000 Daltons;
a dispersant polymer, comprising a copolymer of acrylic acid and sulfonated monomer;
a builder; and
a surfactant, wherein the surfactant is a fatty alcohol alkoxylate of formula I: 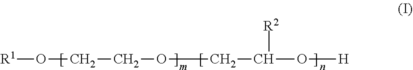
wherein R¹ is a linear or branched, saturated C₈₋₂₄ alkyl group; wherein R² is a linear saturated C₂₋₈ alkyl group; wherein m has an average value of 26 to 42; wherein n has an average value of 4 to 12; wherein m+n is an average value of 30 to 54; wherein the fatty alcohol alkoxylate of formula I has an average ethyleneoxy unit concentration per molecule, X, of >45 wt %; and, wherein the fatty alcohol alkoxylate of formula I has a ratio, Z, equal to the average ethyleneoxy unit concentration per molecule, X, divided by n; wherein the ratio, Z, is <9.5.

2. The automatic dishwashing composition of claim 1, wherein the weight ratio of (i) the maleic acid/olefin copolymer to (ii) the fatty alcohol alkoxylate of formula I is ≤10:1.

3. The automatic dishwashing composition of claim 2, wherein the dispersant polymer further comprises an acrylic acid homopolymer; wherein the dispersant polymer is a blend of (a) the acrylic acid homopolymer and (b) the copolymer of acrylic acid and sulfonated monomer.

4. The automatic dishwashing composition of claim 3, wherein the blend has a blend weight ratio of (a) the acrylic acid homopolymer to (b) the copolymer of acrylic acid and sulfonated monomer of 3:1 to 1:3.

5. The automatic dishwashing composition of claim 4, wherein R¹ is selected from the group consisting of a mixture of a hexadecyl group and an octadecyl group; and wherein R² is a C2 alkyl group.

6. The automatic dishwashing composition of claim 4, wherein the average ethyleneoxy unit concentration per molecule, X, is 50 to 64.5 wt %; and, wherein the ratio, Z, is 4 to 9.4.

7. The automatic dishwashing composition of claim 4, wherein the maleic acid/olefin copolymer is a copolymer of maleic acid and di-isobutylene.

8. The automatic dishwashing composition of claim 4, wherein the surfactant is a mixture of fatty alcohol alkoxylate compounds of formula I, wherein the surfactant is a mixture containing two different alkyl groups R¹, wherein the two different alkyl groups R¹ are hexadecyl groups and octadecyl groups; wherein R² is a C2 alkyl group; wherein the average ethyleneoxy unit concentration per molecule, X, is 50 to 64.5 wt %; and wherein the ratio, Z, is 4 to 9.4.

9. The automatic dishwashing composition of claim 4, further comprising an optional component selected from the group consisting of a bleaching agent, a bleach activator, a bleach catalyst, an enzyme, an aminocarboxylate chelant, a filler, and mixtures thereof; and wherein the builder is selected from the group consisting of alkali metal carbonate, alkali metal bicarbonate, alkali metal percarbonate, alkali metal citrate, ammonium carbonate, ammonium bicarbonate, and ammonium percarbonate.

10. A method of cleaning an article in an automatic dishwashing machine while maintaining the cleanliness of the automatic dishwashing machine, comprising:
providing at least one food soiled article;
providing an automatic dishwashing machine having a drain line with a non-metal strainer;
providing water;
selecting an automatic dishwashing composition according to claim 1, wherein the automatic dishwashing composition is specifically selected both for washing the food soiled article and for maintaining the cleanliness of the non-metal strainer by reducing the buildup of food soil on the non-metal strainer during use of the automatic dishwashing machine;
applying the water and the automatic dishwashing composition to the at least one food soiled article forming a cleaned article and a food soiled water; and
draining the food soiled water through the non-metal strainer.
